(19) United States
(12) Patent Application Publication
(10) Pub. No.: US 2004/0088315 A1
(43) Pub. Date: May 6, 2004

(54) System and method for determining membership of information aggregates

(75) Inventors: Michael D. Elder, Greer, SC (US); Jason Y. Jho, Raleigh, NC (US); Vaughn T. Rokosz, Newton, MA (US); Andrew L. Schirmer, Andover, MA (US); Matthew Schultz, Ithaca, NY (US)

Correspondence Address: Shelley M. Beckstrand, Esq., Attorney at Law, 314 Main Street, Owego, NY, 13827-1616, US

(73) Assignee: International Business Machines Corporation, Armonk, NY

(21) Appl. No.: 10/286,237

(22) Filed: Oct. 31, 2002

(51) Int. Cl. G06F 17/00

(52) U.S. Cl. 707/102

(57) ABSTRACT

A system and method for evaluating an information aggregate by membership includes a metrics database for storing document indicia including document attributes, associated persons and age of creation; a query engine responsive to a user request and the metrics database for (1) aggregating documents having same, unique attributes in an information aggregate; (2) collecting a plurality of documents having non-unique values on a first shared attribute into a first aggregate; (3) determining membership of the aggregate; and a visualization engine for visualizing the membership. The query engine is further operable for determining membership of the information aggregate during first and second time period for visualizing change in membership over time.

### CROSS REFERENCE TO RELATED APPLICATIONS

The following U.S. patent applications are filed concurrently herewith and are assigned to the same assignee hereof and contain subject matter related, in certain respect, to the subject matter of the present application. These patent applications are incorporated herein by reference.

Ser. No. ______, filed ______ for “SYSTEM AND METHOD FOR DETERMINING FOUNDERS OF AN INFORMATION AGGREGATE”, assignee docket LOT920020007US1;

Ser. No. ______, filed ______ for “SYSTEM AND METHOD FOR FINDING THE ACCELERATION OF AN INFORMATION AGGREGATE”, assignee docket LOT920020008US1;

Ser. No. ______, filed ______ for “SYSTEM AND METHOD FOR FINDING THE RECENCY OF AN INFORMATION AGGREGATE”, assignee docket LOT920020009US1;

Ser. No. ______, filed ______ for “SYSTEM AND METHOD FOR EXAMINING THE AGING OF AN INFORMATION AGGREGATE”, assignee docket LOT920020010US1;

Ser. No. ______, filed ______ for “SYSTEM AND METHOD FOR DETERMINING CONNECTIONS BETWEEN INFORMATION AGGREGATES”, assignee docket LOT920020011US1;

Ser. No. ______, filed ______ for “SYSTEM AND METHOD FOR DETERMINING MEMBERSHIP OF INFORMATION AGGREGATES”, assignee docket LOT920020012US1;

Ser. No. ______, filed ______ for “SYSTEM AND METHOD FOR EVALUATING INFORMATION AGGREGATES BY VISUALIZING ASSOCIATED CATEGORIES”, assignee docket LOT920020017US1;

Ser. No. ______, filed ______ for “SYSTEM AND METHOD FOR DETERMINING COMMUNITY OVERLAP”, assignee docket LOT920020018US1;

Ser. No. ______, filed ______ for “SYSTEM AND METHOD FOR BUILDING SOCIAL NETWORKS BASED ON ACTIVITY AROUND SHARED VIRTUAL OBJECTS”, assignee docket LOT920020019US1; and

Ser. No. ______, filed ______ for “SYSTEM AND METHOD FOR ANALYZING USAGE PATTERNS IN INFORMATION AGGREGATES”, assignee docket LOT920020020US1.

### BACKGROUND OF THE INVENTION

1. Technical Field of the Invention

This invention relates to a method and system for analyzing trends in an information aggregate. More particularly, it relates to a membership analysis for identifying and visualizing membership and changes of membership of information aggregates. This membership analysis can also be applied to expertise location.

2. Background Art

Corporations are flooded with information. The Web is a huge and sometimes confusing source of external information which only adds to the body of information generated internally by a corporation's collaborative infrastructure (e-Mail, Notes databases, QuickPlaces, and so on). With so much information available, it is difficult to determine what's important and what's worth looking at.

It is common, then, for people to rely on the people that they know to help them find information that is important. Computer-based tools for information management can therefore be more useful if they help to identify people who might be able to answer questions. Information management tools can also be more useful if they show how the relationships between people and document collections change over time. But such tools typically focus on documents and document content rather than people, and do not typically look at people-to-document relationships, or changes in those relationships over time.

For example, document management systems are known which maintain collections of documents and list the contents of those collections in tabular form. These collection lists may show document authors. A membership list could then be manually derived from these lists. Most collaborative applications do something similar, since it is known to show the names of the people who are posting documents in views that list documents. Internet news groups are somewhat similar, as well. However, these systems generally require manual analysis.

Some collaborative systems maintain lists of membership by requiring users to “join” a collaborative space. A portal (K-station) product from IBM is one example, where users can join a Place by clicking a button. K-station then tracks a list of the people who have joined, considering them “Place members”. However, such place membership is not directly related to document activity and, in general the list of people who have joined a place is much smaller than the list of people who are active in the repositories displayed by the place.

Some collaborative systems use access control as a way of describing membership. If a set of people is explicitly granted access to a collaborative application, in some sense they can be considered members. And if other people are explicitly denied access, then the set of people who can generate document activity is the same as the set of people on the access control list. But this notion only applies at a fairly high level of aggregation, and would not apply to subsets of documents within a secured application. Also, the use of access control as a proxy for membership breaks down in cases where a collaborative application is open to everyone (as in a Quickplace that allows everyone to read it, or as in an Internet newsgroup).

The Lotus Discovery Server (LDS) is a Knowledge Management (KM) tool that allows users to more rapidly locate the people and information they need to answer their questions. It categorizes information from many different sources (referred to generally as knowledge repositories) and provides a coherent entry point for a user seeking information. Moreover, as users interact with LDS and the knowledge repositories that it manages, LDS can learn what the users of the system consider important by observing how users interact with knowledge resources. Thus, it becomes easier for users to quickly locate relevant information.

The focus of LDS is to provide specific knowledge or answers to localized inquiries; focusing users on the documents, categories, and people who can answer their questions. LDS supports expertise location by associating people with categories, based on user activity within a category. But there is a need to improve the expertise location system by applying user activity to more types of document collections, and to look at how the relationships between users and document collections change over time.

It is an object of the invention to provide an improved system and method for analyzing and visualizing the relationships of people to information aggregates.

### SUMMARY OF THE INVENTION

System and method for evaluating an information aggregate by collecting a plurality of documents having non-unique values on a first shared attribute into a first aggregate; determining membership of the aggregate; and visualizing that membership.,

In accordance with an aspect of the invention, there is provided a computer program product configured to be operable evaluating an information aggregate by collecting a plurality of documents having non-unique values on a first shared attribute into a first aggregate; determining membership of the aggregate; and visualizing that membership.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a diagrammatic representation of visualization portfolio strategically partitioned into four distinct domains in accordance with the preferred embodiment of the invention.

FIG. 2 is a system diagram illustrating a client/server system in accordance with the preferred embodiment of the invention.

FIG. 3 is a system diagram further describing the web application server of FIG. 2.

FIG. 4 is a diagrammatic representation of the XML format for wrapping SQL queries.

FIG. 5 is a diagrammatic representation of a normalized XML format, or QRML.

FIG. 6 is a diagrammatic representation of an aggregate in accordance with the preferred embodiment of the invention.

FIG. 7 is a diagrammatic illustration of people associated with an aggregate.

FIG. 8 is a diagrammatic illustration of a GUI for visualizing a membership metric.

FIG. 9 is a flow chart illustrating determining membership of a given aggregate.

### DETAILED DESCRIPTION OF PREFERRED EMBODIMENTS

The Lotus Discovery Server (LDS) is a Knowledge Management (KM) tool that allows users to more rapidly locate the people and information they need to answer their questions. In an exemplary embodiment of the present invention, the functionality of the Lotus Discovery Server (LDS) is extended to include useful visualizations that show the people associated with a community (where a community is a type of information aggregate that is formed by combining documents from a specified set of repositories).

On its lowest level, LDS manages knowledge resources. A knowledge resources is any form of document that contains knowledge or information. Examples include Lotus WordPro Documents, Microsoft Word Documents, webpages, postings to newsgroups, etc. Knowledge resources are typically stored within knowledge repositories—such as Domino.Doc databases, websites, newsgroups, etc.

When LDS is first installed, an Automated Taxonomy Generator (ATG) subcomponent builds a hierarchy of the knowledge resources stored in the knowledge repositories specified by the user. For instance, a document about working with XML documents in the Java programming language stored in a Domino.Doc database might be grouped into a category named ‘Home>Development>Java>XML’. This categorization will not move or modify the document, just record its location in the hierarchy. The hierarchy can be manually adjusted and tweaked as needed once initially created.

A category is a collection of knowledge resources and other subcategories of similar content. Categories represent a more abstract re-organization of the contents of physical repositories, without displacing the available knowledge resources. For instance, in the following hierarchy:

Home (Root of the hierarchy)

Animals

Dogs

Cats

Industry News and Analysis

CNN

ABC News

MSNBC

‘Home>Animals’, ‘Home>Industry News and Analysis’, and ‘Home>Industry News and Analysis>CNN’ are each categories that can contain knowledge resources and other subcategories. Furthermore, ‘Home>Industry News and Analysis>CNN’ might contain documents from www.cnn.com and documents created by users about CNN articles which are themselves stored in a Domino.Doc database.

Knowledge repositories are then grouped into sets, known as communities. A community is a set of repositories primarily utilized by some particular group of people. Communities are only defined by administrative users of the system (unlike categories which can be created by LDS and then modified). If a user interacts with one of the repositories used to define Community A, then he is considered an active participant in that community. Thus, communities represent the physical storage of knowledge resources and provide a mechanism for LDS to observe the activity of a group of people.

As a user interacts with knowledge resources, LDS learns which categories they interact with the most. LDS maintains a score for the user, known as an affinity. An affinity is a rank that numerically captures how often a user interacts with a particular category compared to the level of interaction of other users. Affinities within the system are only important in relation to the other affinities. Once a user's affinity reaches a certain threshold, LDS asks the user if he would like to publish that affinity. These affinities can then be made public, so that when other users search on a topic, LDS can identify users who are knowledgeable on that topic.

These affinities are extremely useful in making inferences about the interests of the users of the system, and in understanding the knowledge trends. In accordance with the present invention, affinities are used to reflect when a particular category (or topic of information) becomes more important than others, indicating that the organization is losing or gaining interest in some topic.

LDS maintains a score for the knowledge resources which are utilized to indicate how important they are to the users of the system. For instance, a document that has a lot of activity around it—such as responses, modifications or simply a high access rate—is perceived as more important than documents which are rarely accessed. This is generically referred to as ‘document value’.

Another capability of LDS is its search functionality. Instead of returning only the knowledge resources (documents) that a standard web-based search engine might locate, LDS also returns the categories that the topic might be found within and the people that are most knowledge about that topic. LDS takes the users' affinities and the document values it has calculated into account when returning the results of a search. Thus, users with high affinities for a particular topic and documents that are rated with a higher document value are more likely to be returned. The present invention can be applied to a set of documents returned by a search; a search can be thought of as returning an information aggregate whose member documents are related by keyword.

The system and method of the preferred embodiments of the invention are built on a framework that collectively integrates data-mining, user-interface, visualization, and server-side technologies. An extensible architecture provides a layered process of transforming data sources into a state that can be interpreted and outputted by visualization components. This architecture is implemented through Java, Servlets, JSP, SQL, XML, and XSLT technology, and essentially adheres to a model-view controller paradigm, where interface and implementation components are separated. This allows effective data management and server side matters such as connection pooling to be independent In accordance with an exemplary embodiment of the invention, information visualization techniques may be implemented through various mediums, including bar charts, pie charts, and tables. Given the simplicity of the visualization types themselves, the context in which they are contained is what makes them powerful mediums to reveal and magnify hidden knowledge dynamics within an organization.

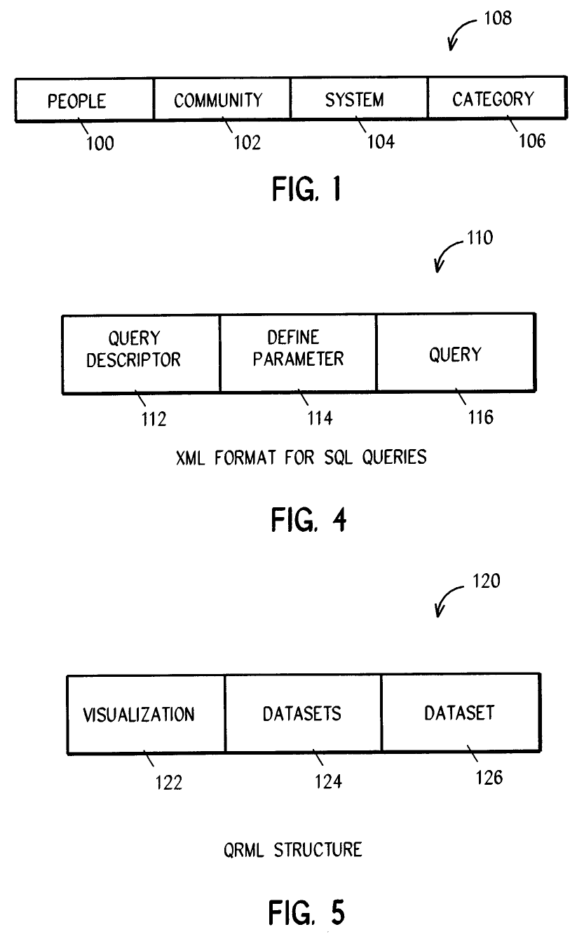

Referring to FIG. 1, a visualization portfolio is strategically partitioned into four distinct domains, or explorers: people 100, community 102, system 104, and category 106. The purpose of these partitioned explorers 100-106 is to provide meaningful context for the visualizations. The raw usage pattern metrics produced from the Lotus Discovery Server (LDS) do not raise any significant value unless there is an applied context to it. In order to shed light on the hidden relationships behind the process of knowledge creation and maintenance, there is a need to ask many important questions. Who are the knowledge creators? Who are the ones receiving knowledge? What group of people are targeted as field experts? How are groups communicating with each other? Which categories of information are thriving or lacking activity? How is knowledge transforming through time? While answering many of these questions, four key targeted domains, or explorer types 100-106 are identified, and form the navigational strategy for user interface 108. This way, users can infer meaningful knowledge trends and dynamics that are context specific.

### People Domain 100

People explorer 100 focuses on social networking, community connection analysis, category leaders, and affinity analysis. The primary visualization component is table listings and associations.

### Community Domain 102

Community explorer 102 focuses on acceleration, associations, affinity analysis, and document analysis for communities. The primary visualization components are bar charts and table listings. Features include drill down options to view associated categories, top documents, and top contributors.

LDS records activities around shared knowledge resources, and this information may be used to link people together. Then, by aggregating these links, the organization's social network may be built. A social network is a group of people where each person has connections or interactions to other members of the group.

### System Domain 104

System explorer 104 focuses on high level activity views such as authors, searches, accesses, opens, and responses for documents. The primary visualization components are bar charts (grouped and stacked). Features include zooming and scrollable regions.

### Category Domain 106

Category explorer 106 focuses on lifespan, acceleration, affinity analysis, and document analysis of categories generated by a Lotus Discovery Server's Automated Taxonomy Generator. The primary visualization components are bar charts. Features include drill down options to view subcategories, top documents, top contributors, category founders, and document activity.

### System Overview

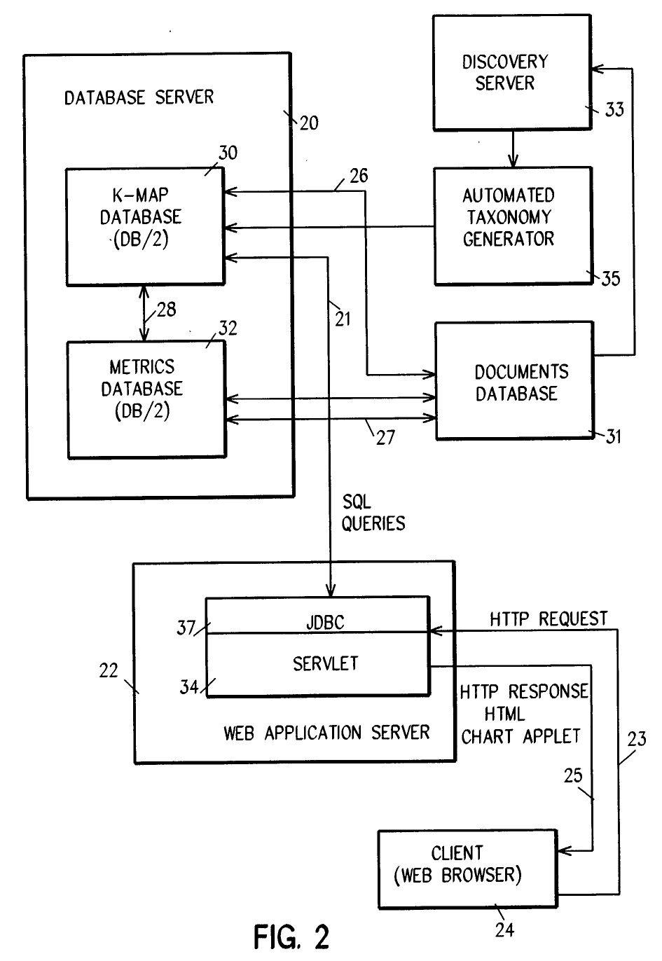

Referring to FIG. 2, an exemplary client/server system is illustrated, including database server 20, discovery server 33, automated taxonomy generator 35, web application server 22, and client browser 24.

Knowledge management is defined as a discipline to systematically leverage information and expertise to improve organizational responsiveness, innovation, competency, and efficiency. Discovery server 33 (e.g. Lotus Discovery Server) is a knowledge system which may deployed across one or more servers. Discovery server 33 integrates code from several sources (e.g., Domino, DB2, InXight, KeyView and Sametime) to collect, analyze and identify relationships between documents, people, and topics across an organization. Discovery server 33 may store this information in a data store 31 and may present the information for browse/query through a web interface referred to as a knowledge map (e.g., K-map) 30. Discovery server 33 regularly updates knowledge map 30 by tracking data content, user expertise, and user activity which it gathers from various sources (e.g. Lotus Notes databases, web sites, file systems, etc.) using spiders.

Database server 20 includes knowledge map database 30 for storing a hierarchy or directory structure which is generated by automated taxonomy generator 35, and metrics database 32 for storing a collection of attributes of documents stored in documents database 31 which are useful for forming visualizations of information aggregates. The k-map database 30, the documents database 31, and the metrics database are directly linked by a key structure represented by lines 26, 27 and 28. A taxonomy is a generic term used to describe a classification scheme, or a way to organize and present information, Knowledge map 30 is a taxonomy, which is a hierarchical representation of content organized by a suitable builder process (e.g., generator 35).

A spider is a process used by discovery server 33 to extract information from data repositories. A data repository (e.g. database 31) is defined as any source of information that can be spidered by a discovery server 33.

Java Database Connectivity API (JDBC) 37 is used by servlet 34 to issue Structured Query Language (SQL) queries against databases 30, 31, 32 to extract data that is relevant to a users request 23 as specified in a request parameter which is used to filter data. Documents database 31 is a storage of documents in, for example, a Domino database or DB2 relational database.

The automated taxonomy generator (ATG) 35 is a program that implements an expectation maximization algorithm to construct a hierarchy of documents in knowledge map (K-map) metrics database 32, and receives SQL queries on link 21 from web application server 22, which includes servlet 34. Servlet 34 receives HTTP requests on line 23 from client 24, queries database server 20 on line 21, and provides HTTP responses (which can include HTML and chart applets) back to client 24 on line 25.

Table 1 is an example SQL query as issued by Servlet 34.

TABLE 1
Example SQL Query

select doctitle, decimal(M.value,16,4) \
from lotusrds.metrics M \
join lotusrds.registry R on (R.metricid = M.metricid and
R.metricname = ‘DOCVALUE’) \
join lotusrds.entity E3 on (E3.entityaliasid = M.entityid1
and E3.entityaclass=1) \
join lotusrds.docmeta D on D.docid = E3.entityname \
join lotusrds.cluster_docs CD on CD.docid = D.docid \
join lotusrds.entity E1 on E1.entityname = CD.clid \
join lotusrds.entity E2 on E2.entityid = E1.entityaliasid \
where E2.entityname like ‘Home>Discovery Server>Spiders%’ \
order by docmetricvalue DESC, doctitle

This example returns the titles of documents that are contained by the category “Home→Discovery Server→Spiders”, as well as in any subcategories of “Spiders”. The query results are sorted by document value, from highest to lowest value. The name of the category (“Home→Discovery Server→Spiders” in the example) is taken from a parameter in Request Header 40 by Servlet 34, and then used by Servlet 34 in constructing dynamic SQL queries 22. Referring to FIG. 4, the category name is an example of a <defineParameter> element 114.

The example query draws on data contained in a number of database tables that are maintained by the Discovery Server. The METRICS table is where all of the metrics are stored, and this query is interested in only the DOCVALUE metric. The REGISTRY table defines the types of metrics that are collected, and is used here to filter out all metrics except the DOCVALUE metric. Records in the METRICS table use identifiers rather than document titles to identify documents. Since the example query outputs document titles, it is necessary to convert document ids to titles. The document titles are stored in the DOCMETA table, and so the document title is extracted by joining the METRICS table to the ENTITY table (to get the document id) and then doing an additional join to DOCMETA (to get the document title).

In order to select documents that belong to a particular category, the categories to which the document belongs also need to be obtained. This information is stored in the CLUSTER_DOCS table, and so the join to CLUSTER_DOCS makes category ids available. These category ids are transformed to category names through additional joins to the ENTITY table.

Discovery server 33, database server 20 and related components are further described in U.S. patent application Ser. No. 10,044,914 filed 15 Jan. 2002 for System and Method for Implementing a Metrics Engine for Tracking Relationships Over Time.

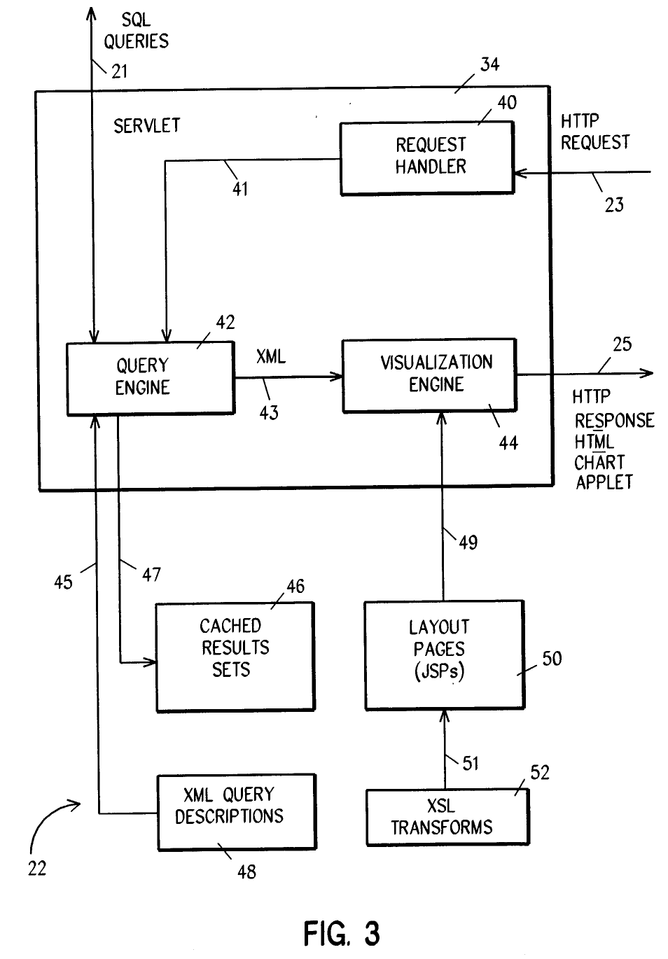

Referring to FIG. 3, web application server 22 is further described. Servlet 34 includes request handler 40 for receiving HTTP requests on line 23, query engine 42 for generating SQL queries on line 21 to database server 20 and result set XML responses on line 43 to visualization engine 44. Visualization engine 44, selectively responsive to XML 43 and layout pages (JSPS) 50 on line 49, provides on line 25 HTTP responses, HTML, and chart applets back to client 24. Query engine 42 receives XML query descriptions 48 on line 45 and caches and accesses results sets 46 via line 47. Layout pages 50 reference XSL transforms 52 over line 51.

In accordance with the preferred embodiment of the invention, visualizations are constructed from data sources 32 that contain the metrics produced by a Lotus Discovery Server. The data source 32, which may be stored in an IBM DB2 database, is extracted through tightly coupled Java and XML processing.

Referring to FIG. 4, the SQL queries 21 that are responsible for extraction and data-mining are wrapped in a result set XML format having a schema (or structure) 110 that provides three main tag elements defining how the SQL queries are executed. These tag elements are <queryDescriptor> 112, <defineParameter> 114, and <query> 116.

The <queryDescriptor> element 112 represents the root of the XML document and provides an alias attribute to describe the context of the query. This <queryDescriptor> element 112 is derived from http request 23 by request handler 40 and fed to query engine 42 as is represented by line 41.

The <defineParameter> element 114 defines the necessary parameters needed to construct dynamic SQL queries 21 to perform conditional logic on metrics database 32. The parameters are set through its attributes (localname, requestParameter, and defaultValue). The actual parameter to be looked up is requestParameter. The localname represents the local alias that refers to the value of requestParameter. The defaultValue is the default parameter value.

QRML structure 116 includes <query> element 116 containing the query definition. There can be one or more <query> elements 116 depending on the need for multiple query executions. A <data> child node element is used to wrap the actual query through its corresponding child nodes. The three essential child nodes of <data> are <queryComponent>, <useParameter>, and <queryAsFullyQualified>. The <querycomponent> element wraps the main segment of the SQL query. The <useparameter> element allows parameters to be plugged into the query as described in <defineParameter>. The <queryAsFullyQualified> element is used in the case where the SQL query 21 needs to return an unfiltered set of data.

When a user at client browser 24 selects a metric to visualize, the name of an XML document is passed as a parameter in HTTP request 23 to servlet 34 as follows:

<input type=hidden name=“queryAlias”

value=“AffinityPerCategory”>

In some cases, there is a need to utilize another method for extracting data from the data source 32 through the use of a generator Java bean. The name of this generator bean is passed as a parameter in HTTP request 23 to servlet 34 as follows:

<input type=hidden name=“queryAlias”value=“PeopleInCommonByCommGenerator”>

Once servlet 34 receives the XML document name or the appropriate generator bean reference at request handler 40, query engine 42 filters, processes, and executes query 21. Once query 21 is executed, data returned from metrics database 32 on line 21 is normalized by query engine 42 into an XML format 43 that can be intelligently processed by an XSL stylesheet 52 further on in the process.

Referring to FIG. 5, the response back to web application server 22 placed on line 21 is classified as a Query Response Markup Language (QRML) 120. QRML 120 is composed of three main elements. They are <visualization> 122, <datasets> 124, and <dataset> 126. QRML structure 120 describes XML query descriptions 48 and the construction of a result set XML on line 43.

The <visualization> element 122 represents the root of the XML document 43 and provides an alias attribute to describe the tool used for visualization, such as a chart applet, for response 25.

The <datasets> element 124 wraps one or more <dataset> collections depending on whether multiple query executions are used.

The <dataset> element 126 is composed of a child node <member> that contains an attribute to index each row of returned data. To wrap the raw data itself, the <member> element has a child node <elem> to correspond to column data.

### Data Translation and Visualization

Referring further to FIG. 3, for data translation and visualization, in accordance with the architecture of an exemplary embodiment of the invention, an effective delineation between the visual components (interface) and the data extraction layers (implementation) is provided by visualization engine 44 receiving notification from query engine 42 and commanding how the user interface response on line 25 should be constructed or appear. In order to glue the interface to the implementation, embedded JSP scripting logic 50 is used to generate the visualizations on the client side 25. This process is two-fold. Once servlet 34 extracts and normalizes the data source 32 into the appropriate XML structure 43, the resulting document node is then dispatched to the receiving JSP 50. Essentially, all of the data packaging is performed before it reaches the client side 25 for visualization. The page is selected by the value parameter of a user HTTP request, which is an identifier for the appropriate JSP file 50. Layout pages 50 receive the result set XML 120 on line 43, and once received an XSL transform takes effect that executes a transformation to produce parameters necessary to launch the visualization.

For a visualization to occur at client 24, a specific set of parameters needs to be passed to the chart applet provided by, for example, Visual Mining's Netcharts solution. XSL transformation 52 generates the necessary Chart Definition Language (CDLs) parameters, a format used to specify data parameters and chart properties. Other visualizations may involve only HTML (for example, as when a table of information is displayed).

An XSL stylesheet (or transform) 52 is used to translate the QRML document on line 43 into the specific CDL format shown above on line 25.

This process of data retrieval, binding, and translation all occur within a JSP page 50. An XSLTBean opens an XSL file 52 and applies it to the XML 43 that represents the results of the SQL query. (This XML is retrieved by calling queryResp.getDocumentElement( )). The final result of executing this JSP 50 is that a HTML page 25 is sent to browser 24. This HTML page will include, if necessary, a tag that runs a charting applet (and provides that applet with the parameters and data it needs to display correctly). In simple cases, the HTML page includes only HTML tags (for example, as in the case where a simple table is displayed at browser 24). This use of XSL and XML within a JSP is a well-known Java development practice.

In Ser. No. ______, filed ______ for “SYSTEM AND METHOD FOR DETERMINING FOUNDERS OF AN INFORMATION AGGREGATE”, assignee docket LOT920020007US1, Table 1 illustrates an example of XML structure 110; Table 2 illustrates an example of the normalized XML, or QRML, structure; Table 3 illustrates an example of CDL defined parameters fed to client 24 on line 25 from visualization engine 44; Table 4 illustrates an example of how an XSL stylesheet 52 defines translation; and Table 5 is script illustrating how pre-packaged document node 43 is retrieved and how an XSL transformation 52 is called to generate the visualization parameters.

An exemplary embodiment of the system and method of the invention may be built using the Java programming language on the Jakarta Tomcat platform (v3.2.3) using the Model-View-Controller (MVC) (also known as Model 2) architecture to separate the data model from the view mechanism.

### Information Aggregate

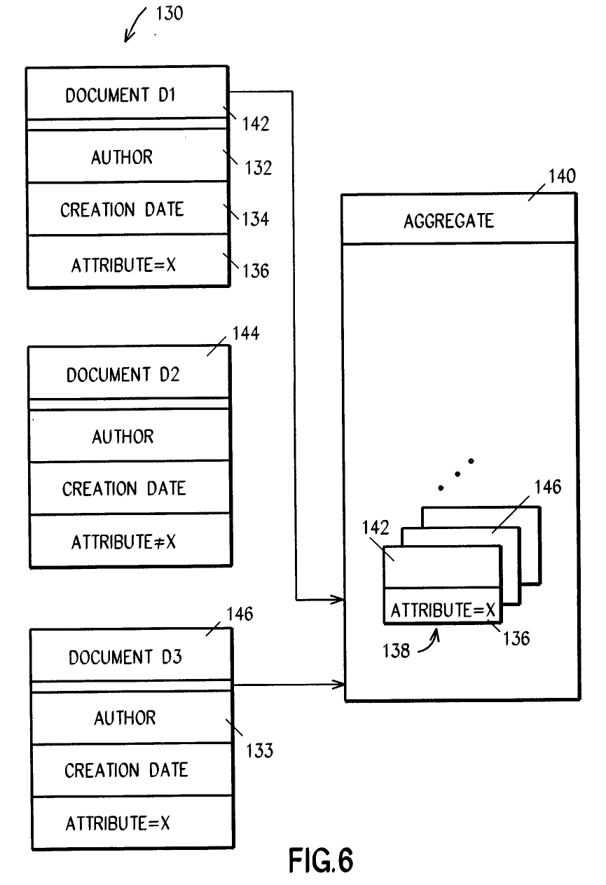

Referring to FIG. 6, a system in accordance with the present invention contains documents 130 such as Web pages, records in Notes databases, and e-mails. Each document 130 is associated with its author 132, and the date of its creation 134. A collection of selected documents 130 forms an aggregate 140. An aggregate 140 is a collection 138 of documents 142, 146 having a shared attribute 136 having non-unique values. Documents 138 can be aggregated by attributes 136 such as:

Category—a collection of documents 130 about a specific topic.

Community—a collection of documents 130 of interest to a given group of people. Such a collection can be formed by identifying a set of knowledge repositories used by a given group of people. The union of the documents in all specified repositories represents the community.

Location—a collection of documents 130 authored by people in a geographic location (e.g. USA, Utah, Massachusetts, Europe).

Job function or role—a collection of documents 130 authored by people in particular job roles (e.g. Marketing, Development).

Group (where group is a list of people)—a collection of documents authored by a given set of people.

Any other attributed 136 shared by a group (and having non-unique values).

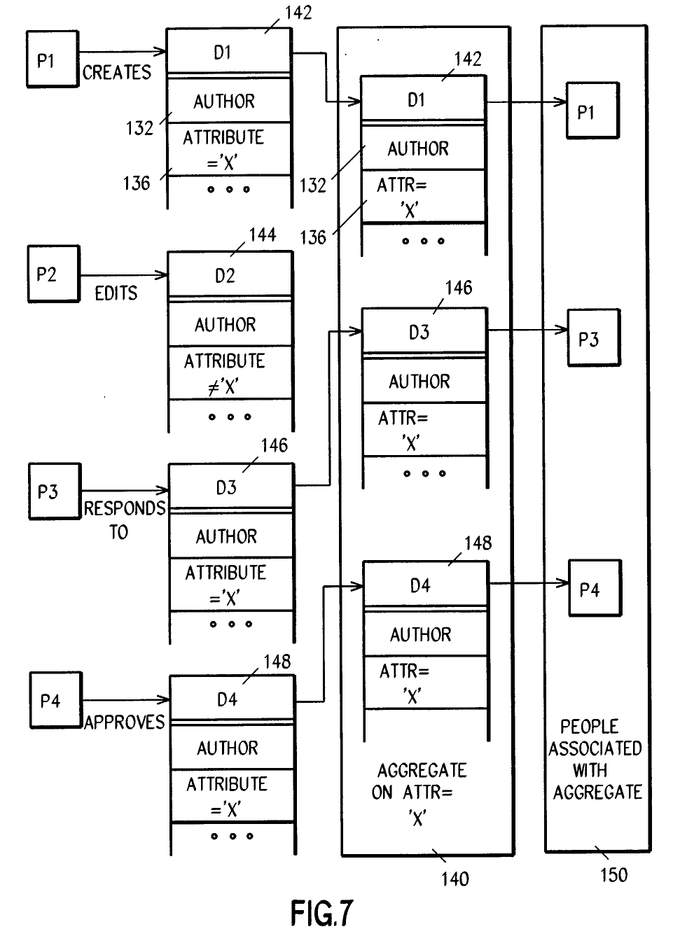

Referring to FIG. 7, people may be associated with an aggregate in several ways. For example, person P1 is associated with document D1 as its creator, person P2 is associated with document D2 as its editor, person P3 is associated with document 146 as a responder, and person P4 is associated with document 148 as its approver. Aggregate 140 on attribute X includes documents 142, 146, and 148, and therefore people 150 associated with aggregate 140 include persons P1, P3 and P4.

### Membership of Information Aggregates

In accordance with the preferred embodiment of the invention, a membership analysis is provided for helping people locate interesting sources of information by examining a visualization of people associated with information, which may change over time. Knowing the membership for an information aggregate provides valuable context in the following ways:

1. If there exist personal connections to the people associated with information, an inference may be drawn as to the potential value of the information. For example, an individual may be more interested in information that is associated with his peers, or his manager,

2. By observing the rate of change in membership, whether an information aggregate is attracting attention over time, or is falling into disuse, may be detected.

Referring to FIG. 7, people may be associated with an aggregate in several ways. For example, person P1 is associated with document D1 as its creator, person P2 is associated with document D2 as its editor, person P3 is associated with document 146 as a responder, and person P4 is associated with document 148 as its approver. Aggregate 140 on attribute X includes documents 142, 146, and 148, and therefore people 150 associated with aggregate 140 include persons P1, P3 and P4.

An exemplary embodiment of the invention is implemented in the context of the Lotus Discovery Server. The Lotus Discovery Server is a system that supports the collection of documents into information aggregates. The aggregates supported by the Discovery Server include categories and communities. A category is a collection of documents that are concerned with the same topic, and these can be organized hierarchically. A community is a collection of documents that are of interest to a particular group of people. The Discovery Server allows definition of a community based on the information repositories used by the community. The Discovery Server tracks activity metrics for the documents that it organizes, so that when a document is created, modified, responded to, or linked to is known.

In general, characteristics of a system to which the present invention is applicable are as follows:

1. The system contains documents. (Examples of documents include Web pages, records in Notes databases, and e-mails).

2. Each document can be associated with its author, and the date of its creation.

3. Documents can be collected together into aggregates.

One example of an aggregate might be a category which could group together documents that concerned a particular topic.

More advanced systems may track additional metrics regarding documents, such as: when someone responds to a document (for example, as in a discussion database or news group); when a document is modified (and by whom); when someone creates a new document that contains a reference to the original document; when someone opens a document; and when the document is returned in a set of search results (and who executed the search). In such systems, the date of the activity and the person who performed the activity are tracked.

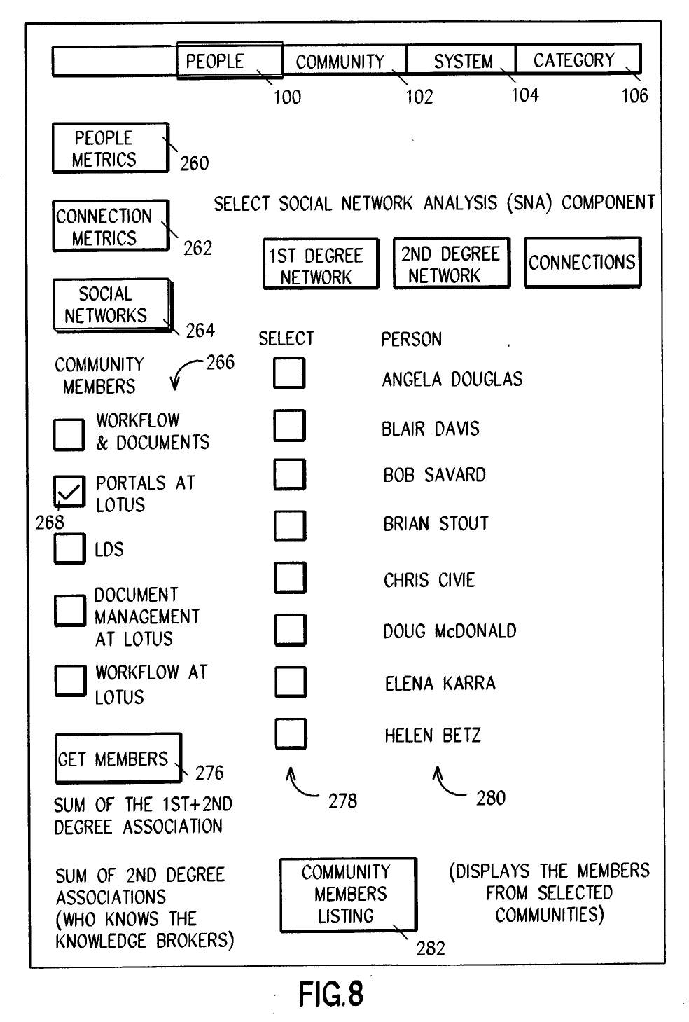

Referring to FIG. 8, an example of a graphical user interface (GUI) at client browser 24 is illustrated for displaying membership of a community. As in FIG. 1, a visualization portfolio is strategically partitioned into four distinct domains, or explorers: people 100, community 102, system 104, and category 106. In this case, people domain 100 is selected. Within people domain 100, a user may then select among people metrics 260, connection metrics 262, and social networks metrics 264. In the case of this example, the user has selected social networks metrics and has selected portals community 268 from among communities 266, and then selected get members 276. (The user may select one or more communities from list 266). By selecting community members listing 282, a list 280 of members appears in the window to the right, together with buttons 278 for selecting individuals for further identification and analysis of their activity with respect to the community.

The list of members 280 may be found by looking at all or selected document activity within a community. This example GUI may be further refined to analyze activity within a fixed time window by specifying start and end times for determining list 280 and viewing successive time periods in a plurality of window displays. It may further be refined to weight activity in order to filter out low contributors. Alternatively, community list 266 may be replaced with a category list, and membership metrics defined with respect to one or more categories selected from the category list.

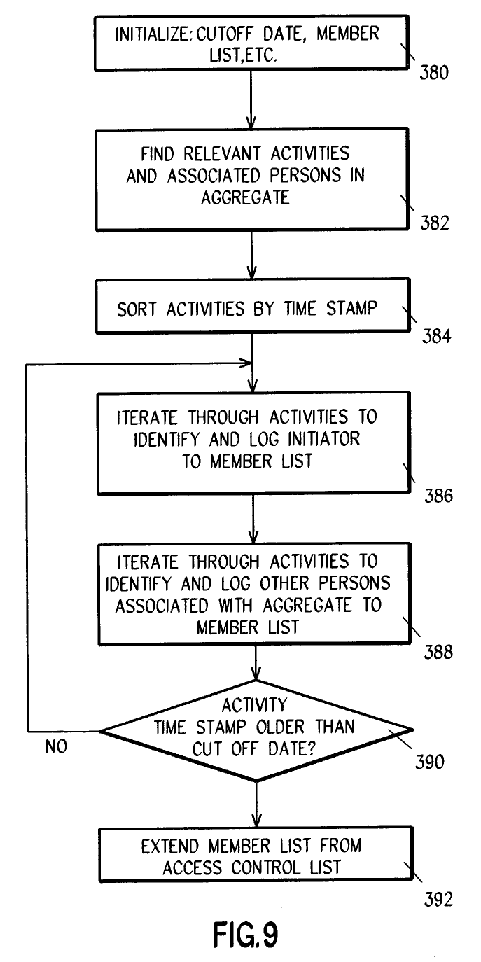

Referring to FIG. 9, the membership of a given aggregate may be determined as follows.

In step 380, a cut off date is initialized, as is the member list.

In step 382, relevant activities and the people associated with these activities are found, and in step 384 sorted by time stamp.

In step 386, the sorted activities are iterated through in time stamp order to find and log to the member list the person (or agent) who initiated the activity.

In step 388, the sorted activities are iterated through to identify and log to the member list other persons associated with the aggregate. For example, a document that is posted for review might contain the names of people who have been asked to review the document. The list of reviewers should then be added to the membership list of the aggregate.

In step 390, searching for membership is stopped upon encountering activity time stamps that are older than a specified cutoff date.

In step 392, the access control list (ACL) of the aggregate (where applicable) is used to extend the membership list. For example, the access control list of an aggregate such as a Quickplace or a File Cabinet in Domino.Doc. Such aggregates often explicitly list in a ACL people who have access to the aggregate, from which can be inferred that access implies membership.

The membership may include non-human agents (such as computers or software agents) that may be interacting with documents. Such agents may or may not be included in the membership list.

In basic systems, membership would be determined based solely on document creation. Anyone who created a document in the aggregate within a specified time period would be considered a member of the aggregate. For more advanced systems, any tracked activity may be used, so that a person would be considered a member of the aggregate if they showed any activity at all around the documents in the aggregate (opens, edits, responses, links), or if they were referenced within a document contained in the aggregate.

The membership metric can be determined from the entire contents of the aggregate, rather than just the activity over a specified time period. Membership can be filtered based on thresholds that are calculated from the activity metrics. For example, a person may be considered a member of the aggregate only if he created 5 or more documents over a specified time period.

Rates of change in membership over time may be calculated, using algorithms such as those described below:

1. Calculate membership over time by using a sliding time window. In this approach, activity over a given time period, starting with the most recent activity, is first determined. Then, the calculation is repeated, but this time moving the start state some period into the past. This process continues, moving move the starting date into the past until there are no activities; for example, by examining the activity over the last year, starting today; then, examining a years worth of activity starting last week, then starting two weeks ago, and so on. This gives a measure of how membership changes over time.

2. Calculate membership as of a given date, and then store the result of the calculation in a persistent data store. Repeat the calculation at regular intervals, to then build up a data store that represents membership trends over time.

3. Use various filters to look at membership, such as by restricting view to those people who are active, rather than the union of people who are active and who are referenced.

4. Develop system-wide reports of membership or of rates of change in membership in situations where collections of aggregates exist. For example, where documents are organized into categories, sum up the membership rates across all categories, and display the results in a single table or graph. Such a system-wide visualization helps make cross-aggregate comparisons.

The membership analysis provides a way to evaluate aggregates. This generalizes the idea of an aggregate so that it applies to things other than simple document containers and uses a range of document activity (not just creation activity) to identify membership, which broadens the set of people associated with an aggregate (for example, to include people that only read documents). By encompassing the notion of membership changes over time, aggregates of potential interest may be identified based on whether they are gaining or losing people.

### Advantages Over the Prior Art

It is an advantage of the invention that there is provided an improved system and method for locating people who are associated with an information aggregate, and understanding how the associations between people and aggregates change over time.

### Alternative Embodiments

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. Method for evaluating an information aggregate, comprising:
collecting a plurality of documents having non-unique values on a first shared attribute into a first aggregate;
determining membership of said aggregate; and
visualizing said membership.

2. The method of claim 1, further comprising:
determining membership of said information aggregate during a first time period;
determining membership of said information aggregate during a second time period;
visualizing change in said membership between said first and second time periods.

3. The method of claim 1, further comprising filtering said membership by document activity.

4. The method of claim 1, further comprising including non-human agents within said membership.

5. The method of claim 1, further comprising including within said membership those persons creating a document.

6. The method of claim 5, further comprising including within said membership those persons opening, editing, responding, linking, or referencing a document in said aggregate.

7. The method of claim 5, further comprising including within said membership those persons referenced with a document.

8. The method of claim 2, further comprising:
determining aggregate membership changes over time by using a sliding time window.

9. The method of claim 2, further comprising:
repetitively determining and storing aggregate membership as of a succession of time intervals to build a data store representing membership trends over time.

10. The method of claim 1, further comprising:
collecting a plurality of documents having non-unique values on a second shared attribute into a second aggregate;
determining membership of said second aggregate; and
visualizing membership or rates of change of membership across said first and second aggregates; thereby facilitating cross-aggregate membership comparisons.

11. A system for evaluating an information aggregate, comprising:
a metrics database for storing document indicia including document attributes, associated persons and age of creation;
a query engine responsive to a user request and said metrics database for aggregating documents having same, unique attributes in an information aggregate;
said query engine further for
collecting a plurality of documents having non-unique values on a first shared attribute into a first aggregate;
determining membership of said aggregate; and
a visualization engine for visualizing said membership.

12. The system of claim 11, said query engine further for:
determining membership of said information aggregate during a first time period;
determining membership of said information aggregate during a second time period;
visualizing change in said membership between said first and second time periods.

13. The system of claim 11, said query engine further for: filtering said membership by document activity.

14. The system of claim 11, said query engine further for including non-human agents within said membership.

15. The system of claim 11, said query engine further for including within said membership those persons creating a document.

16. The system of claim 15, said query engine further for including within said membership those persons opening, editing, responding, linking, or referencing a document in said aggregate.

17. The system of claim 12, said query engine further for determining aggregate membership changes over time by using a sliding time window.

18. The system of claim 12, said query engine further for repetitively determining and storing aggregate membership over a succession of time intervals to build a data store representing membership trends over time.

19. The system of claim 11, said query engine further for:
collecting a plurality of documents having non-unique values on a second shared attribute into a second aggregate;
determining membership of said second aggregate; and
visualizing membership or rates of change of membership across said first and second aggregates; thereby facilitating cross-aggregate membership comparisons.

20. A program storage device readable by a machine, tangibly embodying a program of instructions executable by a machine to perform method steps for evaluating an information aggregate, said method comprising:
collecting a plurality of documents having non-unique values on a first shared attribute into a first aggregate;
determining membership of said aggregate; and
visualizing said membership.

21. The program storage device of claim 20, said method further comprising:
determining membership of said information aggregate during a first time period;
determining membership of said information aggregate during a second time period;
visualizing change in said membership between said first and second time periods.

22. The program storage device of claim 20, said method further comprising:
collecting a plurality of documents having non-unique values on a second shared attribute into a second aggregate;
determining membership of said second aggregate; and
visualizing membership or rates of change of membership across said first and second aggregates;
thereby facilitating cross-aggregate membership comparisons.

23. A computer program product for evaluating an information aggregate, according to the method comprising:
collecting a plurality of documents having non-unique values on a first shared attribute into a first aggregate;
determining membership of said aggregate; and
visualizing said membership.
